(19) United States
(12) Patent Application Publication
(10) Pub. No.: US 2010/0023488 A1
(43) Pub. Date: Jan. 28, 2010

(54) SYSTEM AND METHOD FOR INTEGRATING INTERACTIVE VIDEO SERVICE AND YELLOW PAGE SERVICE

(75) Inventors: Sung Jin HUR, Daejeon (KR); Ki Hyuk NAM, Daejeon (KR); Sung Joo KANG, Daejeon (KR); Wan CHOI, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon (KR)

(21) Appl. No.: 12/260,607

(22) Filed: Oct. 29, 2008

(30) Foreign Application Priority Data
Jul. 22, 2008 (KR) 10-2008-0070938

(51) Int. Cl. G06F 7/06; G06F 17/30; G06F 15/16

(52) U.S. Cl. 707/3; 709/203; 707/E17.014; 707/E17.044

(57) ABSTRACT

Provided is a method for providing the integration service of an interactive video and a yellow page, which includes receiving a video request message of a client, selecting multimedia data corresponding to the received message, and transmitting the selected multimedia data to the client, receiving a search message of the client, searching brand information corresponding to the search message in a yellow page database, and selecting optimal brand information of the searched brand information using a service use record of the client, and transmitting the searched optimal brand information to the client. It is possible for user to easily obtain necessary information while viewing video by integrating an interactive video service and a yellow page service. Accordingly, it is possible to provide information customized to user's characteristics by configuring and using a user profile.

### CROSS-REFERENCE TO RELATED APPLICATIONS

This application claims priority under 35 U.S.C. §119 to Korean Patent Application No. 10-2008-0070938, filed on Jul. 22, 2008, the disclosure of which is incorporated herein by reference in its entirety.

### BACKGROUND OF THE INVENTION

1. Field of the Invention

The present disclosure relates to a system and a method for integrating an interactive video service and a yellow page service, and more particularly, to a system and a method for integrating an interactive video service and a yellow page service, which can provide user custom information.

This work was supported by the IT R&D program of MIC/IITA [2008-P1-21-08J50, Technical Standard Development for Two-way Video Application Service Based on SOA]

2. Description of the Related Art

An interactive video service system and a yellow page providing service according to the conventional technology apply different transmission technologies and control technologies, and consequently exchanged information has different contents and kinds. Accordingly, the two services take different application fields and have been applied and developed independently.

FIG. 1 is a block diagram of the conventional interactive video service providing system.

Referring to FIG. 1, a client terminal connected to the Internet receives multimedia data through a video transmission module of a server. A system according to the conventional technology must generate, maintain and manage a control channel for a service between a client and a server other than a channel for the transmission of multimedia. The client transmits a control message through the control channel, and the transmitted control message is suitably processed by a control processing module of the server. A server main module transfers a command necessary for a video transmitting module according to the process result of the control processing module, and multimedia contents transmitted by the video transmitting module are stored in a file system. The multimedia contents stored in the file system are maintained and managed by the server main module.

The interactive video service according to the conventional technology only transmits the multimedia data, but do not transmit a yellow page for the multimedia data. Accordingly, when a user intends to obtain information of articles in a displayed video while viewing the video, there exists limitation in that the user must search the information with the Internet by itself.

FIG. 2 is a schematic diagram illustrating the conventional yellow page service providing method. Referring to FIG. 2, a client receives yellow page basic information from a server to perform certain necessary tasks. When more detailed information about a specific directory of the received yellow page basic information is required, the client requests corresponding information to the server. The server extracts the corresponding information from a yellow page database (DB) to transmit the extracted information to the client.

An on-line yellow page service according to the conventional technology is provided to the users of personal computers (PCs) in large portal sites.

However, due to the development of the communication functions of television (TV) terminals such as a high-definition television (HDTV) and an Internet protocol television (IPTV), a need of the yellow page service using the TV terminal having the simple access and adjustment of a user emerges. Moreover, a need of a convergence service capable of obtaining the information of a displayed video while viewing the video emerges.

### SUMMARY

Therefore, an object of the present invention is to provide a system and a method for integrating an interactive video service and a yellow page service, which can be applied to a terminal environment having an intuitive and simple user interface.

To achieve these and other advantages and in accordance with the purpose of the present invention as embodied and broadly described herein, a server for integrating an interactive video service and a yellow page service in accordance with an aspect of the present invention includes: a storage unit for storing yellow page information, multimedia data and user profile information; and a control unit for performing controlling to transmit multimedia data requested by a client, read out yellow page information corresponding to a search message transmitted by the client from the storage unit, and transmit the read yellow page information to the client.

To achieve these and other advantages and in accordance with the purpose of the present invention, a client for integrating an interactive video service and a yellow page service in accordance with another aspect of the present invention includes: an input unit for receiving a user input; and a control unit for performing controlling to request video or brand information according to the user input, and display data transmitted from a server in response to the request.

To achieve these and other advantages and in accordance with the purpose of the present invention, a method for providing an integration service of an interactive video and a yellow page in accordance with another aspect of the present invention includes: receiving a video request message of a client, selecting multimedia data corresponding to the received message, and transmitting the selected multimedia data to the client; receiving a search message of the client; searching brand information corresponding to the search message in a yellow page database, and selecting optimal brand information of the searched brand information using a service use record of the client; and transmitting the searched optimal brand information to the client.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram of the conventional interactive video service providing system;

FIG. 2 is a schematic diagram illustrating the conventional yellow page service providing method;

FIG. 3 is a block diagram of a system for integrating an interactive video service and a yellow page service according to an embodiment of the present invention;

FIG. 4 is a block diagram of a client of a system for integrating an interactive video service and a yellow page service according to an embodiment of the present invention;

FIG. 5 is a flowchart illustrating a method for integrating an interactive video service and a yellow page service according to an embodiment of the present invention; and

FIG. 6 is a flowchart illustrating a method for integrating an interactive video service and a yellow page service according to another embodiment of the present invention.

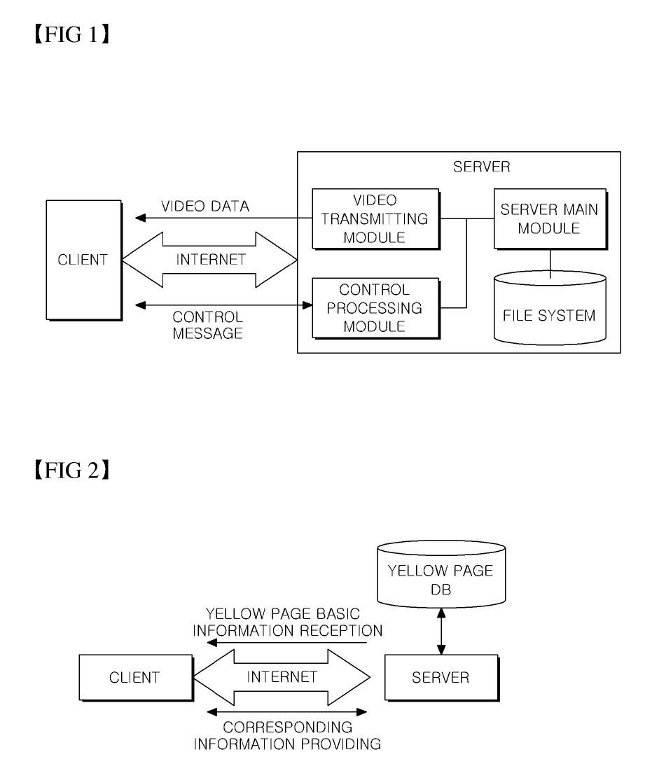

### DETAILED DESCRIPTION OF EMBODIMENTS

Hereinafter, specific embodiments will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

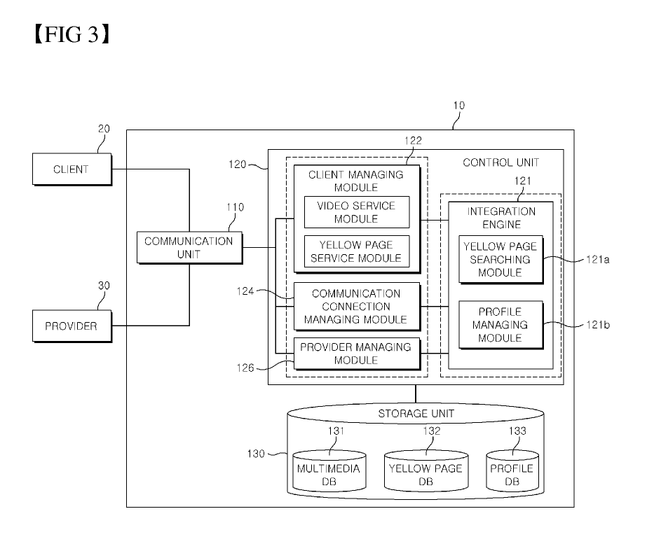

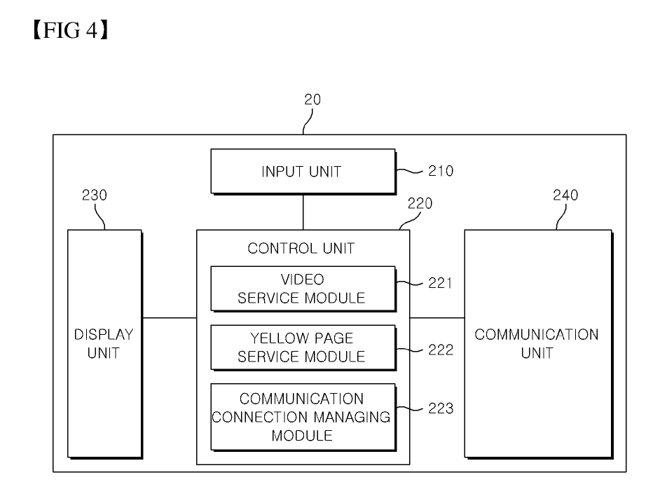

FIG. 3 is a block diagram of a system for integrating an interactive video service and a yellow page service according to an embodiment of the present invention.

Referring to FIG. 3, a server 10 may include a communication unit 110, a control unit 120, and a storage unit 130.

The communication unit 110 generates a communication session together with a client terminal 20 (hereinafter, referred to as a client) and a provider terminal 30 (hereinafter, referred to as a provider), and performs data communication with them, according to a control signal from the control unit 120.

The storage unit 130 stores yellow page information, multimedia data and user profile information. For this, the storage unit 130 may include a multimedia database (DB) 131, a yellow page database (DB) 132 and a profile database (DB) 133.

The multimedia database 131 stores the multimedia data for providing the interactive video service.

The yellow page database 132 stores the yellow page information including brand information. The brand information may include at least one of a brand name, brand spec information, price information and provider information.

The profile database 133 stores the profile data of each of users. Since users can access to the server 10 via the one client 20 and request a service to it, the profile data may be sectioned for each of the users without being sectioned for the client 20 to thereby be generated and stored.

The control unit 120 performs controlling to receive a video request message from the client 20, read out multimedia data corresponding to the received video request message from the multimedia database 131 of the storage unit 130 and transmit the read multimedia data. Moreover, the control unit 120 controls for the client 20 receiving the multimedia data to receive a search message (e.g., a search message of a brand displayed on a video) associated with the received multimedia data, read out brand information corresponding to the received search message from the yellow page database 132 of the storage unit 130 and transmit the read brand information to the client 20. Herein, the search message may include user's unique information (hereinafter, referred to as a user unique information) and a search keyword input by the user.

The control unit 120 includes an integration engine 121 and a client managing module 122 for the integration service of a video and a yellow page.

The client managing module 122 performs controlling to configure and maintain a communication interface with the client 20. For this, the client managing module 122 includes a video service module for the interactive video service, and a yellow page service module for the yellow page service.

The integration engine 121 includes a yellow page searching module 121a and a profile managing module 121b. The yellow page searching module 121a searches brand information corresponding to a search keyword received from the client 20 in the yellow page database 132 of the storage unit 130.

The profile managing module 121b extracts user profile data on the basis of user unique information received from the client 20 from the profile database 133 of the storage unit 130.

That is, the profile managing module 121b searches the brand information corresponding to the search keyword and reflects characteristics of each of users in the searched brand information with the user profile data, thereby extracting custom search information optimized to each of users.

Moreover, the profile managing module 121b stores and analyzes a search message (e.g., user unique information and a search keyword) transmitted from the client 20, detects purchase information, preference information, etc for each of users, configures or updates user profile data, and reflects the user profile data in the profile database 133 of the storage unit 130.

It is possible to provide custom information optimized to user characteristics through the profile data management for each of users. That is, when a user interests in a specific brand, all information associated with the specific brand are not transmitted uniformly, but only specific information to which personal profile data are applied is sorted out and provided to the user. Therefore, the user can sort out and receive only information suitable for its own taste.

To maintain and manage the latest yellow page information, the control unit 120 includes a provider managing module 123.

The provider managing module 123 performs controlling to configure a communication with the provider 30, and stores brand information transmitted from the provider 30 in the yellow page database 132 of the storage unit 130. Accordingly, the server 10 according to the present invention can easily maintain the latest yellow page data.

The control unit 120 may further include a communication connection managing module 124 which performs controlling to establish the communication channel between the client 20 and the provider 30 by user's request.

That is, when the communication connection managing module 124 receives a message (hereinafter, referred to as an additional information request message) requesting the communication establishment with the provider 30 for more detailed additional information from the client 20 receiving user custom brand information (hereinafter, referred to as optimal brand information), the communication connection managing module 124 performs controlling to connect the communication channel between the provider 30 providing brand information and the user.

FIG. 4 is a block diagram of a client of a system for integrating an interactive video service and a yellow page service according to an embodiment of the present invention.

Referring to FIG. 4, the client 20 includes an input unit 210, a display unit 210, a communication unit 240, and a control unit 220.

The input unit 210 receives information (e.g., video request information or search information) from a user. The display unit 230 displays video information, yellow page information, etc to the user. To ease an input interface environment of the user, a menu selection scheme (e.g., a scheme which sets an input menu on a television (TV) screen and inputs information through the selection input of a TV remote controller) may be used in the input of the user.

The control unit 220 requests video information or brand information to the server 10 according to the user input received by the input unit 230, and performs controlling to display data, which are transmitted from the server 10 in response to the request, on the display unit 230 to the user.

For this, the control unit 220 an interactive video service processing module 221 for an interactive video service and a yellow page service processing module 222 for a yellow page service.

The interactive video service processing module 221 generates, maintains and manages an interactive video session for the communication with the server 10, and requests a video through the generated and maintained interactive video session. Moreover, the interactive video service processing module 221 performs controlling to receive multimedia data corresponding to the requested video from the server 10 and display the received data to a user.

The yellow page service processing module 222 performs controlling to generate, maintain and manage a yellow page service session for the communication with the server 10, transmit the user input (e.g., a search message) to the server 10 through the generated and maintained yellow page service session, and receive optimal brand information corresponding to the user input from the server 10.

The control unit 220 may further include a communication connection managing module 223 for connecting the direct communication with the provider 30.

That is, when the user requests the communication establishment with the provider 30 for obtaining additional information after receiving the optimal brand information, the communication connection managing module 223 configures an additional information request message and transmits it to the server 10. Thus, the communication connection managing module 223 allows to connect and maintain the direct communication channel between the provider 30 providing the optimal brand information and the user.

Such a client 20 may be implemented with at least one of a TV terminal, a mobile phone and a personal digital assistant (PDA) which have an intuitive user interface and can ease an user input through a menu scheme.

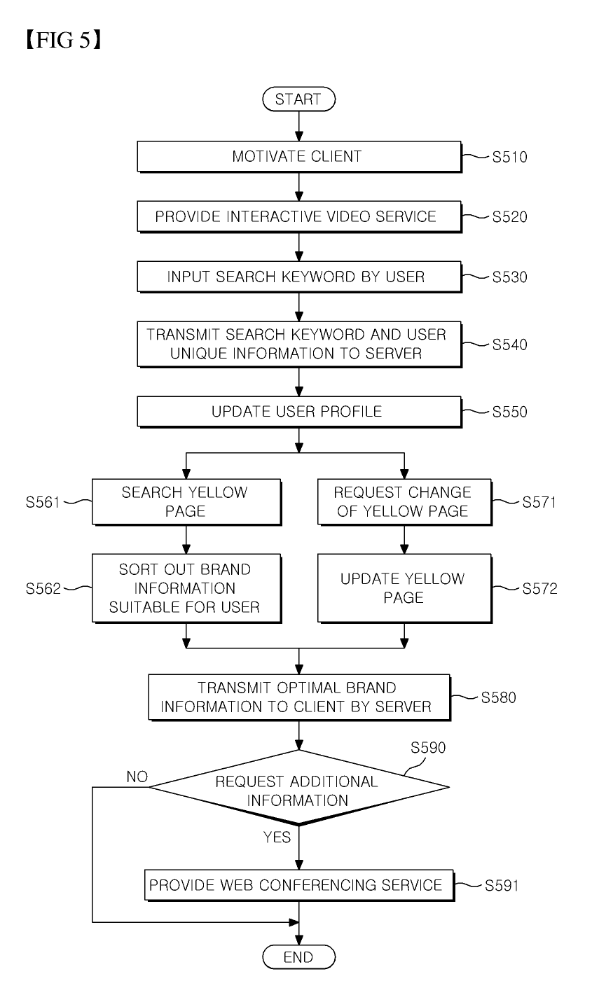

FIG. 5 is a flowchart illustrating a method for integrating an interactive video service and a yellow page according to an embodiment of the present invention.

Referring to FIG. 5, a user motivates the client 20 for the interactive video service and the yellow page integration service with buttons or menus provided in the input interface of the client 20 in operation S510.

When the user requests the interactive video service, a corresponding video request message is transmitted to the server 10 through the client 20 and the interactive video service is provided by the server 10 in operation S520.

The user inputs a search keyword for desired information through the interface or text input window of a menu scheme for requesting brands or information associated with video contents which are being provided at present in operation S530, and a search message including the search keyword and the user unique information of the user is transmitted to the server 10 through the client 20 in operation S540.

The server 10 searches the user profile data using the user unique information included in the received search message, and updates a corresponding user profile data on the basis of a search keyword input by the user when necessary in operation S550.

The server 10 extracts specific brand information from the yellow page database 132 on the basis of the search keyword in operation S561, and sorts out only brand information which are determined to be suitable for the user among the extracted brand information using the user profile data in operation S562.

In a case where a change factor occurs in information related to the brand of the provider 30, when the provider 30 requests the change of the information to the server 10 in operation S571, the server 10 updates the relevant information in the yellow page database 132 in operation S572.

The optimal brand information, which is determined to be most suitable for the user and extracted by the server 10, is transmitted to the client 20 in operation S580. Subsequently, the optimal brand information is provided to the user.

At this point, when the user requests the server 10 to obtain the direct communication channel with the provider 30 for requesting more detailed additional information on corresponding information in operation S590, the server 10 may provide a service capable of performing the direct communication between the user and the provider 30 in various types such as web conferencing or chatting between the client 20 and the provider 30 in operation S591.

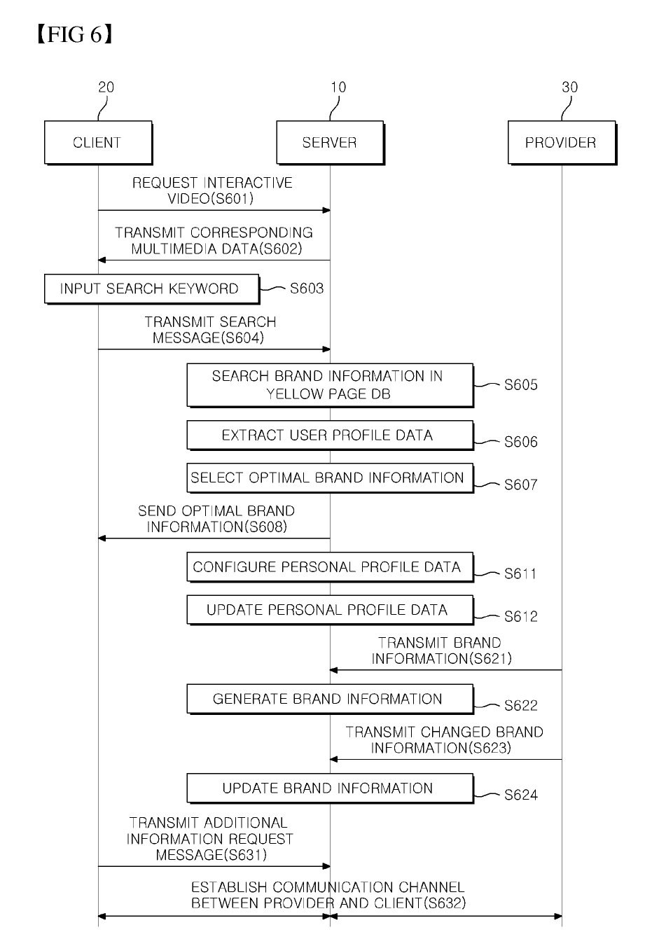

FIG. 6 is a flowchart illustrating a method for integrating an interactive video service and a yellow page service according to another embodiment of the present invention.

Referring to FIG. 6, the server 10 receives a video request message of the client 20 in operation S601, and selects multimedia data corresponding to the received message from the multimedia database 131 and transmits the selected data to the client 20 in operation S602.

The client 20 receives a search keyword of the user in operation S603, and transmits a search message including the received search keyword and user unique information to the server 10 in operation S604.

The server 10 receives a search message from the client 20 and searches brand information corresponding to the received search keyword in the yellow page database 132 in operation S605. Subsequently, the server 10 selects the optimal brand information of the searched brand information using the service use record of the client 20 in the searched brand information.

That is, personal profile data are extracted from the profile database 133 using the user unique information in operation S606, and brand information, which is matched with the extracted personal profile data among the searched brand information, is sorted out and selected as optimal brand information in operation S607.

The server 10 transmits the searched optimal brand information to the client 20 in operation S608.

Moreover, the server 10 generates the profile database 133 including personal profile information of each of users with the search keyword and the user unique information included in the received search message in operation S611. The server 10 may also update pre-generated personal profile information in operation S612. The operations S611 and S612 may be performed with the operations S605 and S607 simultaneously or sequentially.

Hereinafter, operations S621 to S624 for updating the yellow page database 132 of the server 10 by the provider 30 will be described in detail.

To generate brand information, the provider 30 transmits brand information including the information of the provider 30 to the server 10, and the server 10 receives the brand information transmitted by the provider 30 in operation S621. The server 10 stores the received brand information in the yellow page database 132 and generates data in operation S622.

Moreover, in a case where the provider 30 intends to update the brand information, the provider 30 transmits changed brand information to the server 10, and the server 10 receives the changed brand information transmitted by the provider 30 in operation S623. The server 10 reflects the changed brand information received from the provider 30 in the yellow page database 132 to update data in operation S624.

Hereinafter, operations establishing the direct communication channel between the client 20 and the provider 30 will be described in detail.

The user receiving optimal brand information can request the direct communication with the provider 30 for additional information. That is, the user sends an additional information request message to the server 10 through the client 20 in operation S631, and the server 10 establishes the communication channel between the provider 30 providing the optimal brand information and the client 20 in operation S632. At this point, the communication channel may be established in various types such as web conferencing and the providing of a chatting environment.

Embodiments of the present invention enable a user to easily obtain information associated with a displayed video while viewing the video by integrating an interactive video service and a yellow page.

Embodiments of the present invention are capable of building a user profile and providing information which is customized to user's characteristics on the basis of the user profile, thereby providing information of a high hit rate without unnecessary information.

Embodiments of the present invention can increase the access and convenience of users by being implemented in a terminal environment having a clear and simple user interface.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A server for integrating an interactive video service and a yellow page service, comprising:
a storage unit for storing yellow page information, multimedia data and user profile information; and
a control unit for performing controlling to transmit multimedia data requested by a client, read out yellow page information corresponding to a search message transmitted by the client from the storage unit, and transmit the read yellow page information to the client.

2. The server of claim 1, wherein the storage unit comprises:
a multimedia database for storing multimedia data;
a yellow page database for storing brand information having at least one of brand names, brand spec information, price information and provider information; and
a profile database for storing profile data of each of users.

3. The server of claim 2, wherein the search message comprises search keywords and user unique information.

4. The server of claim 3, wherein the control unit comprises:
a yellow page searching module for searching the brand information corresponding to the search keyword in the yellow page database;
a profile managing module for extracting user profile data corresponding to the user unique information in the profile database; and
a integration engine for sorting out brand information matched with the user profile data among the extracted brand information.

5. The server of claim 4, wherein the profile managing module configures or updates the profile database using the search keyword and the user unique information.

6. The server of claim 4, wherein the control unit further comprises a provider managing module for performing controlling to receive brand information transmitted by a provider, and storing the received brand information in the yellow page database.

7. The server of claim 4, wherein the control unit further comprises a communication connection managing module for performing controlling to connect the communication channel between a provider providing the brand information and the client when receiving an additional information request message from the client.

8. A client for integrating an interactive video service and a yellow page service, comprising:
an input unit for receiving a user input; and
a control unit for performing controlling to request video or brand information according to the user input, and display data transmitted from a server in response to the request.

9. The client of claim 8, wherein the control unit comprises:
a video service module for performing controlling to display multimedia data transmitted from the server to a user; and
a yellow page service module for performing controlling to transmit the user input to the server, and receive brand information corresponding to the user input from the server.

10. The client of claims 8, wherein the client is any one of a television terminal, a mobile phone and a personal digital assistant.

11. A method for providing an integration service of an interactive video and a yellow page, comprising:
receiving a video request message of a client, selecting multimedia data corresponding to the received message, and transmitting the selected multimedia data to the client;
receiving a search message of the client;
searching brand information corresponding to the search message in a yellow page database, and selecting optimal brand information of the searched brand information using a service use record of the client; and
transmitting the searched optimal brand information to the client.

12. The method of claim 11, wherein the search message comprises search keywords and user unique information.

13. The method of claim 12, further comprising at least one of:
generating a profile database having personal profile information of each of users using the search keywords and the user unique information; and
updating the generated personal profile information using the search keywords and the user unique information.

14. The method of claim 13, wherein the searching of the brand information comprises:
searching brand information corresponding to the search keyword in the yellow page database;
extracting user profile data in the profile database using the user unique information; and
selecting optimal brand information matched with the user profile data among the searched brand information.

15. The method of claim 11, further comprising receiving brand information transmitted by a provider, and storing the received brand information in the yellow page database.

16. The method of claim 15, further comprising receiving brand information changed by the provider, and updating the yellow page database using the changed brand information.

17. The method of claim 11, further comprising connecting a communication channel between a provider providing the optimal brand information and a client when receiving an additional information request message transmitted by the client receiving the optimal brand information.
